(19) United States
(12) Patent Application Publication
(10) Pub. No.: US 2009/0232108 A1
(43) Pub. Date: Sep. 17, 2009

(54) I/Q IMBALANCE ESTIMATION USING SYNCHRONIZATION SIGNALS IN LTE SYSTEMS

(75) Inventors: Afshin Haghighat, Ile-Bizard (CA); Shahrokh Nayeb-Nazar, Sainte-Julie (CA); Jiang Chang, Brooklyn, NY (US); I-Tai Lu, Dix Hills, NY (US); Chang-Soo Koo, Melville, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/398,418

(22) Filed: Mar. 5, 2009

Related U.S. Application Data
(60) Provisional application No. 61/034,921, filed on Mar. 7, 2008.

(51) Int. Cl. H04L 27/00; H04J 11/00

(52) U.S. Cl. 370/336; 375/260

(57) ABSTRACT

A method and apparatus perform I/Q imbalance estimation and compensation using synchronization signals in LTE systems. Primary and secondary synchronization signals (P-SCH and S-SCH), which carry synchronization information, are embedded in each LTE frame, and are used for receiver I/Q imbalance estimation. Additionally, the performance may be significantly improved by optimally selecting the training data in I/Q imbalance estimation.

This application claims priority from U.S. Provisional Patent Application No. 61/034,921, filed Mar. 7, 2008 which is incorporated by reference as if fully setforth.

### FIELD OF INVENTION

This application is related to wireless communications.

### BACKGROUND

Orthogonal Frequency Division Multiplexing (OFDM) is a spectral efficient technique that facilitates communication over frequency selective fading channels. It has been adopted as the basic modulation scheme for many modern broadband wireless communication systems, such as Institute of Electrical and Electronics Engineers (IEEE) 802.11a/g/n Wireless Local Area Networks (WLAN), IEEE 802.16d/e Wireless Metropolitan Area Networks (WiMAX) and Third Generation Partnership Project (3GPP) Long Term Evolution (LTE) systems.

Conventional OFDM receivers employ the super-heterodyne architecture for down-converting the received radio signal to the baseband. In recent years, the zero-intermediate frequency (IF) (or direct-conversion) architecture has been regarded as an attractive alternative to the conventional super-heterodyne architecture in low-power, fully integrated receiver design. In the current direct-conversion receivers, the In-Phase and Quadrature Phase (I/Q) demodulation is performed in the analog domain. As a result, the gain and phase imbalances between the I and Q paths come into being due to the imperfection of the analog component design. Since the mitigation of I/Q imbalance in a direct-conversion receiver is not trivial, baseband compensation techniques are sought. Such techniques can be implemented in the digital domain. Many algorithms have been proposed for I/Q estimation and compensation in OFDM systems. Some proposed algorithms are based on the IEEE 802.11a/n systems, in which the preamble consisting of training symbols can be used for I/Q imbalance estimation. Other proposed algorithms estimate I/Q imbalance with the aid of a specially-designed pilot structure. However, these requirements on frame structure can not be met in LTE systems. Standard independent I/Q imbalance estimation algorithms based on blind signal processing are needed.

### SUMMARY

A method and apparatus perform I/Q imbalance estimation and compensation using synchronization signals in LTE systems. Primary and secondary synchronization signals (P-SCH and S-SCH), which carry synchronization information in each LTE frame, are used for receiver I/Q imbalance estimation. Additionally, the performance may be significantly improved by optimally selecting the training data in I/Q imbalance estimation.

### BRIEF DESCRIPTION OF THE DRAWINGS

A more detailed understanding may be had from the following description, given by way of example in conjunction with the accompanying drawings wherein:

FIG. 1 is a functional block diagram of a WTRU configured to implement the described methods;

FIG. 2 shows the structure of the LTE frame and synchronization signals; and

FIG. 3 shows the synchronization signals used for I/Q imbalance estimation.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

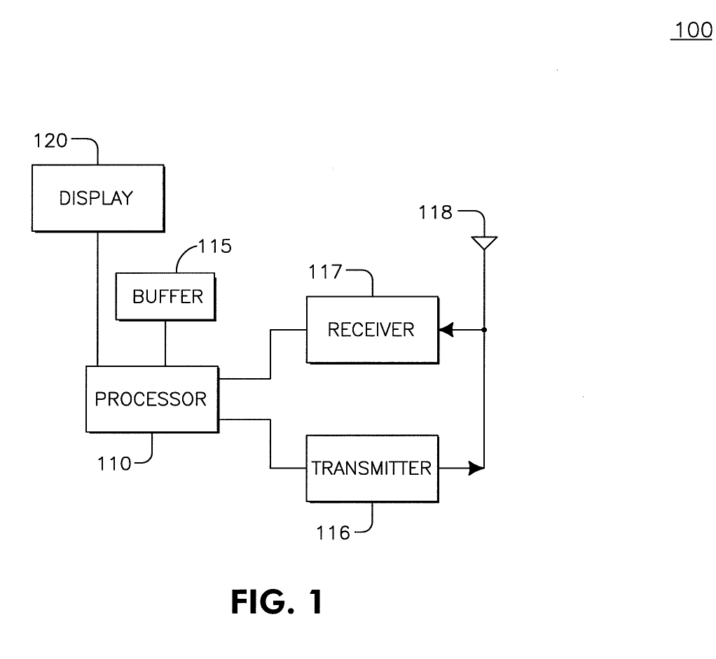

FIG. 1 is a functional diagram of a wireless transfer/receive unit (WTRU) configured to perform the methods described below. In addition to the components that may be found in a typical WTRU, the WTRU 100 includes a processor 110 with an optional buffer 115, a receiver 117, a transmitter 116, an antenna 118 and a display 120. The processor 110 is configured to perform I/Q estimation. The receiver 117 and the transmitter 116 are in communication with the processor 115. The antenna 118 is in communication with both the receiver 117 and the transmitter 116 to facilitate the transmission and reception of wireless data.

In a communication receiver, the Radio Frequency (RF) signal before down conversion can be defined as:

r(t)=y(t)e^{j2πf}^{_{c}}^{t} Equation (1)

where y(t) is the equivalent low pass complex baseband signal of r(t), f_{c} is the carrier frequency, and a noise term is included.

In a direct-conversion receiver, signal r(t) is down-converted by a mixer with I/Q imbalance. This imperfection can be modeled by a complex Local Oscillator (LO) with time function, as follows:

S_{LO}(t)=cos (2πf_{c}t)−jg sin(2πf_{c}t+φ) Equation (2)

where parameter g is the receiver I/Q amplitude imbalance and φ is the phase imbalance.

Next, two parameters, K₁ and K₂, which are functions of the I/Q imbalance parameters g and φ, can be defined as

$$\{ \begin{matrix}{K}_{1} = \frac{1 + g {e}^{- j φ}}{2} = \frac{1 + γ}{2} \\ {K}_{2} = \frac{1 - g {e}^{j φ}}{2} = \frac{1 - {γ}^{*}}{2}\end{matrix} \qquad Equation ( 3 )$$

where y=ge^{jφ} and [·]* denotes a complex conjugate. Therefore, \tilde{x}_{LO}(t) can be reformulated as

S_{LO}(t)=K₁e^{-j2πf}^{_{c}}^{t}+K₂e^{j2πf}^{_{c}}^{t} Equation (4)

In the presence of receiver I/Q imbalance, the received signal r(t) after down-conversion and low pass filtering (LPF) then becomes

z(t)=LPF {r(t)S_{LO}(t)}=K₁y(t)+K₂y*(t) Equation (5)

Equivalently, the RF imperfection can be also described in frequency domain as

Z(f)=K₁Y(f)+K₂Y*(−f) Equation (6)

where Z(f) and Y(f) are the Fourier transform of z(t) and y(t), respectively.

In an OFDM system, one OFDM symbol carries K complex symbols Xₖ(l) where l and k are the indices for OFDM symbols and subcarriers, respectively. Each OFDM symbol modulates a subcarrier with frequency fₖ=k/Tᵤ where Tᵤ is the subcarrier symbol duration. The OFDM modulation is implemented by taking N-point (N>K) inverse discrete Fourier transform (IDFT) with a sampling period T=Tᵤ/N. To avoid inter-symbol-interference (ISI) caused by multipath channel, a cyclic prefix of length T_{g}=N_{g}T is pre-appended to each OFDM symbol. Thus, the duration for each OFDM symbol is Tₛ=Tᵤ+T_{g} and the transmitted complex baseband signal can be described by

$$x ( t ) = \frac{1}{\sqrt{{T}_{u}}} {\sum }_{l = - ∞}^{+ ∞} {\sum }_{k = - K / 2}^{K / 2 - 1} {X}_{k} ( l ) {e}^{j 2 π {f}_{k} ( t - {T}_{g} - {lT}_{s} )} u ( t - {lT}_{s} ) \qquad Equation ( 7 )$$

where u(t) is a window function which is defined as

$$u ( t ) = \{ \begin{matrix}1 , & 0 \leq t < {T}_{s} \\ 0 , & else .\end{matrix} \qquad Equation ( 8 )$$

After being transmitted through a frequency selective fading channel with the equivalent lowpass channel impulse response h(τ, t), the received signal is sampled and demodulated with Fast Fourier Transform (FFT). If the channel is assumed to be time invariant during the transmission of one OFDM symbol, the demodulated data symbol of the lth OFDM symbol may be expressed by

Yₖ(l)=Hₖ(l)Xₖ(l)+nₖ(l), k=−K/2, . . . , (K/2−1) Equation (9)

where nₖ(l) is the complex additive white Gaussian noise and Hₖ(l) is the channel transfer response function at subcarrier frequency fₖ.

In the presence of I/Q imbalance as defined by Equation (6), the I/Q imbalance introduces image interference from mirrored subcarriers such as the kth and −kth. From Equation (6) and Equation (9), the demodulated signals on the kth and −kth subcarriers of the lth OFDM symbol with I/Q impairment can be expressed as follows:

$$\{ \begin{matrix}{Z}_{k} ( l ) = {K}_{1} {Y}_{k} ( l ) + {K}_{2} {Y}_{- k}^{*} ( l ) + {W}_{k} ( l ) \\ {Z}_{- k}^{*} ( l ) = {K}_{2}^{*} {Y}_{k} ( l ) + {K}_{1}^{*} {Y}_{- k}^{*} ( l ) + {W}_{- k}^{*} ( l )\end{matrix} \qquad Equation ( 10 )$$

where Wₖ(l) and W₋ₖ(l) are additive noise term on the corresponding subcarriers.

Equation (10) can further be rewritten in a matrix form as follows:

Z=K·Y+W Equation (11)

where

$$\begin{matrix}Z = {[ {Z}_{k} ( l ) {Z}_{- k}^{*} ( l ) ]}^{T} , & Y = {[ {Y}_{k} ( l ) {Y}_{- k}^{*} ( l ) ]}^{T} \\ W = {[ {W}_{k} ( l ) {W}_{- k}^{*} ( l ) ]}^{T} , & K = [ \begin{matrix}{K}_{1} & {K}_{2} \\ {K}_{2}^{*} & {K}_{1}^{*}\end{matrix} ]\end{matrix} \qquad Equation ( 12 )$$

and [·]^{T} denotes the matrix transposition operation.

The I/Q imbalance estimation method described below exploits the synchronization channel embedded in each LTE frame. FIG. 1 shows a type 1 frame structure that is applicable to frequency division duplex (FDD) in LTE communication systems.

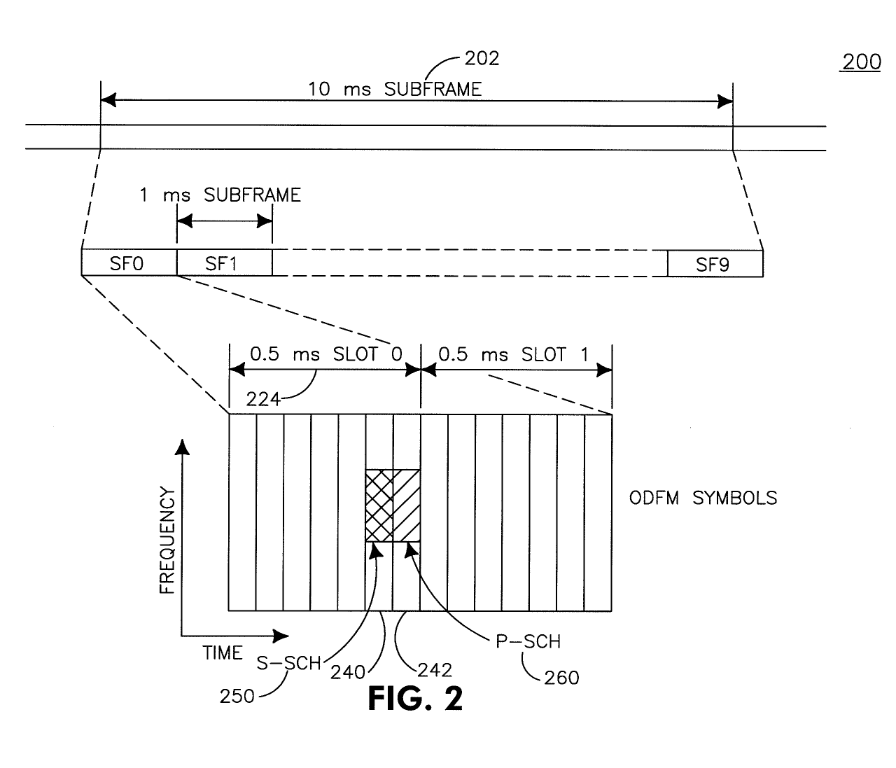

Referring to FIG. 2, each LTE frame 202 is 10 ms long and consists of 10 subframes (SFs) numbered from SF0 to SF9. Frame SF0, SF1 and SF9 are shown. Each SF is 1 ms long and consists of 2 slots. Thus, each frame contains 20 slots numbered from Slot 0 to Slot 19. The primary and secondary synchronization signals P-SCH 250 and S-SCH 260 are transmitted twice for each frame in Slot 0 (224) and Slot 10. P-SCH 250 and S-SCH 260 are carried by two consecutive OFDM symbols. The P-SCH 250 and S-SCH 260 symbols are transmitted, respectively, in the sixth and seventh OFDM symbols of Slot 0 (224) shown as symbols 240 and 242. The P-SCH 250 and S-SCH 260 are repeated in Slot 10 at the sixth and seventh symbols (not shown). Both signals occupy 63 subcarriers including the DC subcarrier, and the 63 subcarriers are centered at the DC subcarrier. While this example shows consecutively numbered frames, slots and symbols, the method may be applied equivalently in other multicarrier-based systems as long as they have adjacent reference symbols

The P-SCH 250 symbols for a primary synchronization signal is generated from a frequency-domain Zadoff-Chu sequence dᵤ(n) according to the following:

$${d}_{u} ( n ) \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad Equation ( 13 )$$

where the Zadoff-Chu root sequence index u={25,29,34}.

The symbol sequence d(0), . . . , d(61) is used for the S-SCH 250 symbols in a second synchronization signal as an interleaved concatenation of two length-31 binary sequences. The concatenated sequence is scrambled with a scrambling sequence given by the primary synchronization signal.

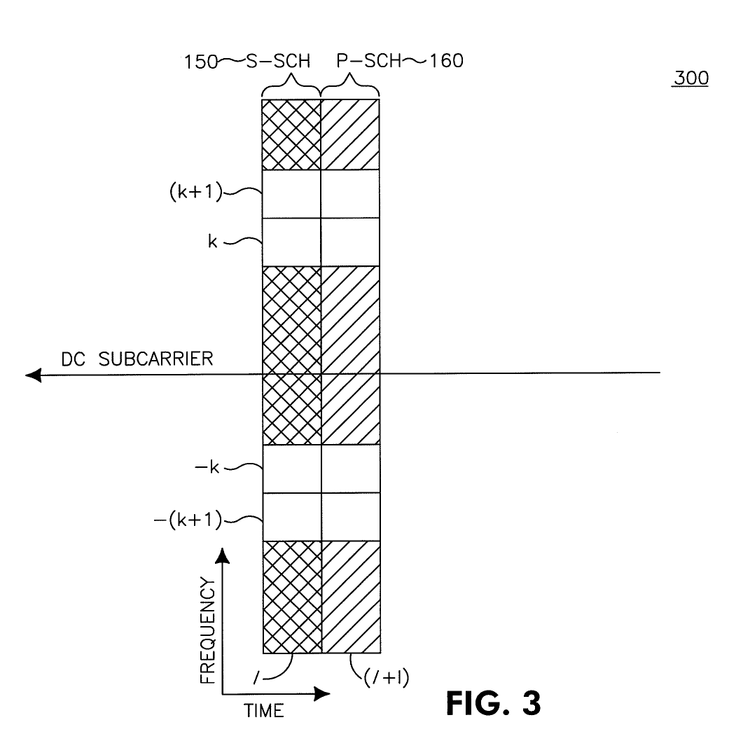

Following standard cell search procedures, the WTRU receives the frequency domain sequences used by the S-SCH 250 and P-SCH 260 channel. The processor 115 processes the known frequency domain sequences as the training data for I/Q imbalance estimation. As shown in FIG. 3, the S-SCH 150 is conveyed by the lth OFDM symbol and the P-SCH 160 is conveyed on the (l+1)^{th} OFDM symbol. The data on the symmetric and adjacent subcarriers are used by the processor 115 to estimate the unknown parameters (I/Q imbalance and channel transfer response) by solving a set of equations using least square (LS) like methods.

In FIG. 3, the data on the kth subcarrier and lth OFDM symbol are represented by Xₖ (l). In order to derive the I/Q imbalance, the processor 115 reformulates the terms that represent the parameters of the received signal. Thus, Equation (11) can be rewritten in matrix form as

Z=P·C+W Equation (14)

where W is the noise vector defined in Equation (11), and where in Equation (14), received signal vector Z, OFDM symbol data matrix P and I/Q imbalance parameter vector C are defined by the following:

$$Z = {[ {Z}_{k} ( l ) {Z}_{- k}^{*} ( l ) ]}^{T}$$

$$P = [ \begin{matrix}{X}_{k} ( l ) & 0 & {X}_{- k}^{*} ( l ) & 0 \\ 0 & {X}_{k} ( l ) & 0 & {X}_{- k}^{*} ( l )\end{matrix} ] \\ \begin{matrix}C = {[ {c}_{1} {c}_{2} {c}_{3} {c}_{4} ]}^{T} \\ = {[ {K}_{1} {H}_{k} ( l ) {K}_{2}^{*} {H}_{k} ( l ) {K}_{2} {H}_{- k}^{*} ( l ) {K}_{1}^{*} {H}_{- k}^{*} ( l ) ]}^{T}\end{matrix}$$

where [·]^{T} is the transposition operation. This reformulation of Equation (14) results in separating the data component from the channel transfer response component and I/Q imbalance component facilitating the estimation of the I/Q imbalance.

Therefore, two equations can be obtained for each pair of the symmetric subcarriers. To use the LS estimation method effectively, the number of independent equations must be greater or equal to the number of unknown parameters. In Equation (14), there are four unknown parameters (c1-c4) that need to be estimated. Thus, at least four equations are required for the LS based estimation method. To reduce the number of unknown parameters, the processor 115 assigns identical frequency-domain channel transfer response values for the adjacent symbols. For instance, if two adjacent symbols l and l+1 of two symmetric subcarriers k and −k are used for estimation, then the channel transfer response values are:

Hₖ(l)=Hₖ(l+1) and H−ₖ(l)=H−ₖ(l+1). Equation (15)

Using the four training data values Xₖ (l), X−ₖ (l), Xₖ (l+1), and X−ₖ (l+1), the processor 115 extends and reformulates Equation (14) as follows:

\tilde{Z}=\tilde{P}·C+\tilde{W} Equation (16)

where \tilde{Z}=[Zₖ(l) Z₋ₖ*(l) Zₖ(l+1) Z₋ₘ*(l+1)]^{T}, \tilde{W} is the noise vector corresponding to the four subcarriers and

$$\tilde{P} = [ \begin{matrix}{X}_{k} ( l ) & 0 & {X}_{- k}^{*} ( l ) & 0 \\ 0 & {X}_{k} ( l ) & 0 & {X}_{- k}^{k} ( l ) \\ {X}_{k} ( l + 1 ) & 0 & {X}_{- k}^{*} ( l + 1 ) & 0 \\ 0 & {X}_{k} ( l + 1 ) & 0 & {X}_{- k}^{*} ( l + 1 )\end{matrix} ] \qquad Equation ( 17 )$$

The processor 115 estimates the I/Q imbalance parameter vector C by using a LS method to determine I/Q imbalance parameter vector estimate Ĉ:

\hat{C}=[\hat{c}₁ \hat{c}₂ \hat{c}₃ \hat{c}₄]^{T}=(\tilde{P}^{H}\tilde{P})⁻¹\tilde{P}^{H}\tilde{Z} Equation (18)

where [·]^{H} is the Hermitian transposition operation.

From the I/Q imbalance parameter vector estimate Ĉ, the processor 115 derives the estimate of the I/Q imbalance parameter a as follows:

From Equation (4) the parameters k₂ and k₁ are related as follows:

$$\frac{{k}_{2}^{*}}{{k}_{1}} = \frac{1 - γ}{1 + γ} = α \qquad Equation ( 19 )$$

The estimation of a is obtained by:

$$\hat{α} = \frac{1}{2} [ \frac{{\hat{c}}_{2}}{{\hat{c}}_{1}} + {( \frac{{\hat{c}}_{3}}{{\hat{c}}_{4}} )}^{*} ] \qquad Equation ( 20 )$$

Thus, the I/Q imbalance parameter estimate_is derived by:

$$\hat{γ} = \frac{1 - \hat{α}}{1 + \hat{α}} \qquad Equation ( 21 )$$

Consequently, the I/Q imbalance parameters K₁ and K₂ are estimated by solving for parameter estimates \hat{K}₁, and \hat{K}₂ respectively using the parameter estimate â in Equation (3).

Further, to improve the estimation performance, the parameter a can be estimated by averaging over an additional number of subcarriers and OFDM symbols. From Equation (11), the demodulated signal without I/Q imbalance can be recovered by

$${\hat{K}}^{- 1} = \frac{1}{{\vert {\hat{K}}_{1} \vert}^{2} - {\vert {\hat{K}}_{2} \vert}^{2}} \times [ \begin{matrix}{\hat{K}}_{1}^{*} & - {\hat{K}}_{2} \\ - {\hat{K}}_{2}^{*} & {\hat{K}}_{1}\end{matrix} ] \qquad Equation ( 22 )$$

where Y and Z are defined in Equation (11) and [□]⁻¹ [denotes the matrix inversion operation. After I/Q imbalance compensation with Equation (21), regular algorithms can be used for subsequent detection.

Instead of using data from the four subcarriers defined in Equation (16) for I/Q imbalance estimation, data on symmetric adjacent subcarriers may be used, such as Xₖ (l, X−ₖ (l), X₍ₖ₊₁₎(l) and X₋₍ₖ₊₁₎(l), for I/Q imbalance estimation. It is assumed that

Hₖ(l)=H₍ₖ₊₁₎(l) and H−ₖ(l)=H₋₍ₖ₊₁₎(l) Equation (23)

Similarly, data on the eight subcarriers as shown in FIG. 2 can be used in estimation as well, i.e., Xₖ (l), X−ₖ (l), X₍ₖ₊₁₎(l). X₋₍ₖ₊₁₎ (l), X−ₖ (l+1), X₍ₖ₊₁₎ (l+1) and X−₍ₖ₊₁₎ (l+1). Correspondingly, it is assumed that

Hₖ(l)=Hₖ₊₁(l)=Hₖ(l+1)=Hₖ₊₁(l+1) H₋ₖ(l)=H₋₍ₖ₊₁₎(l)=H₋ₖ(l+1)=H₋₍ₖ₊₁₎(l+1) Equation (24)

In practice, the matrix \tilde{P} corresponding to some sets of training data could become singular or ill-conditioned. Thus, the matrix elements may be examined to insure that only valid data is used for estimation. In addition, although sometimes the matrix \tilde{P} is not singular, it could be ill-conditioned and consequently lead to a poor estimation. Therefore, this data may also be discarded in I/Q imbalance estimation for better performance.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for in-phase and quadrature-phase (I/Q) imbalance estimation in a wireless communication comprising:
receiving a plurality of orthogonal frequency division multiplex (OFDM) symbols;
determining frequency domain sequences used by a primary synchronization channel (P-SCH) and a secondary synchronization channel (S-SCH) from the communication; and
performing I/Q imbalance estimation using the determined frequency domain sequences.

2. The method of claim 1, further comprising:
estimating a plurality of I/Q imbalance values and channel transfer response values based on data from symmetric and adjacent subcarriers.

3. The method of claim 2, wherein estimating of the plurality of I/Q imbalance values and channel transfer response values is performed according to a least square (LS) method.

4. The method of claim 3, further comprising:
assigning frequency-domain channel transfer response values that are identical for adjacent symbols of two symmetric and adjacent subcarriers.

5. The method of claim 3, wherein the number of adjacent subcarriers is even and at least two.

6. The method of claim 1, further comprising:
separating the plurality of OFDM symbols into data components, channel transfer response components and I/Q components.

7. A wireless transmit/receive unit (WTRU) configured to perform in-phase and quadrature-phase (I/Q) imbalance estimation in a wireless communication, comprising:
a receiver configured to receive a plurality of orthogonal frequency division multiplex (OFDM) symbols;
a processor configured to determine frequency domain sequences used by a primary synchronization channel (P-SCH) and a secondary synchronization channel (S-SCH) from the communication; and
the processor further configured to perform I/Q imbalance estimation using the determined frequency domain sequences.

8. The WTRU of claim 7, wherein the processor is further configured to estimate a plurality of I/Q imbalance values and channel transfer response values based on data from symmetric and adjacent subcarriers.

9. The WTRU of claim 8, wherein the processor estimates the plurality of I/Q imbalance values and channel transfer response values according to a least square (LS) method.

10. The WTRU of claim 8, wherein the processor is configured to assign identical frequency-domain channel transfer response values for adjacent symbols of two symmetric and adjacent subcarriers.

11. The WTRU of claim 8, wherein the number of adjacent subcarriers is even and at least two.

12. The WTRU of claim 7, wherein the processor is further configured to separate the plurality of OFDM symbols into data components, channel transfer response components and I/Q components.
